(19) United States
(12) Patent Application Publication
(10) Pub. No.: US 2026/0095758 A1
(43) Pub. Date: Apr. 2, 2026

(54) METHOD FOR APPLICATION CLASS OF SERVICE IN ZERO TRUST CAMPUS NETWORK

(71) Applicant: Extreme Networks, Inc., San Jose, CA (US)

(72) Inventors: Donald B. Grosser, Apex, NC (US); Mahendra Samarya, Fremont, CA (US); Charles Bickford, Needham, MA (US); Kevin Yohe, II, Bow, NH (US); Suveena James, Leander, TX (US); Michael Brady, Durham, NH (US)

(73) Assignee: Extreme Networks, Inc., San Jose, CA (US)

(21) Appl. No.: 18/902,257

(22) Filed: Sep. 30, 2024

(51) Int. Cl. H04W 12/033; H04W 12/088

(52) U.S. Cl. CPC H04W 12/033; H04W 12/088

(57) ABSTRACT

Disclosed herein are system, method, and computer program product aspects for providing packets from an agent-based zero trust network access (ZTNA) user device class of service in a campus network. Some aspects of this disclosure relate to a user equipment (UE) including a memory and a processor. The processor is configured to generate a packet that include a payload and an inner header and generate an encrypted packet by encrypting the packet. The processor is further configured to generate a combined packet based on the encrypted packet and an outer header. The outer header indicates a class of service corresponding to the packet. The processor is further configured to transmit the combined packet to a campus network via a secured tunnel.

### BACKGROUND

### Field

The described aspects generally relate to application class of service in a zero trust network access (ZTNA) network. For example, some aspects of this disclosure relate to providing packets from an agent-based ZTNA user device class of service in a campus network.

### SUMMARY

Some aspects of this disclosure include apparatuses and methods for application class of service in a zero trust network access (ZTNA) network, and more specifically, providing packets from an agent-based ZTNA user device class of service in a campus network.

Some aspects of this disclosure relate to a user equipment (UE) including a memory and a processor. The processor is configured to generate a packet that includes a payload and an inner header and generate an encrypted packet by encrypting the packet. The processor is further configured to generate a combined packet based on the encrypted packet and an outer header. The outer header indicates a class of service corresponding to the packet. The processor is further configured to transmit the combined packet to a campus network via a secured tunnel.

Some aspects of this disclosure relate to a method of a user equipment (UE). The method includes generating a packet that includes a payload and an inner header and generating an encrypted packet by encrypting the packet. The method further includes generating a combined packet based on the encrypted packet and an outer header. The outer header indicates a class of service corresponding to the packet. The method further includes transmitting the combined packet to a campus network via a secured tunnel.

Some aspects of this disclosure relate to a non-transitory computer-readable medium (CRM) including instructions to, upon execution of the instructions by one or more processors of a user equipment (UE), cause the policy enforcement application to perform operations. The operations include generating a packet that includes a payload and an inner header and generating an encrypted packet by encrypting the packet. The operations further include generating a combined packet based on the encrypted packet and an outer header. The outer header indicates a class of service corresponding to the packet. The operations further include transmitting the combined packet to a campus network via a secured tunnel.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE DRAWINGS

The accompanying drawings are incorporated herein and form a part of the specification.

FIG. 1 illustrates an exemplary system that implements an agent-based ZTNA user device access and a campus user device access, according to some aspects.

FIG. 2 illustrates an exemplary system that implements an agent-based ZTNA user device class of service (CoS) via a campus network, according to some aspects.

FIG. 3 illustrates a block diagram of apparatuses for application CoS in a zero trust network access (ZTNA) network, according to some aspects.

FIG. 4 illustrates an example method of implementing application CoS in the ZTNA network by the agent-based ZTNA user device, according to some aspects.

FIG. 5 illustrates an example method of implementing application CoS in the ZTNA network by a policy enforcement application, according to some aspects.

FIG. 6 illustrates an example combined packet for implementing application CoS in the ZTNA network, according to some aspects of the disclosure

FIG. 7 illustrates an example computer system for implementing some aspects of the disclosure or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Provided herein are apparatuses and methods for application class of service in a zero trust network access (ZTNA) network, and more specifically, providing packets from an agent-based ZTNA user device class of service (CoS) in a campus network.

A campus network, such as a network serving a corporation or an organization, may be configured with one or more policy enforcement applications, such as switches for wired connections and/or access points (APs) for wireless connections. In some aspects, the campus network is configured with a plurality of network policies that govern types of access and priorities granted to a device connected to the campus network or a packet that arrives at the campus network. For example, an administrator of the campus network may configure a set of network policies that give different groups of devices or different groups of identities different access, resources, and/or priorities. A device in an accounting department may be given access to accounting department related documents. A device in a human resource (HR) department may be given access to HR related documents. In some aspects, when a packet arrives at the campus network, the campus network determines a network policy to be applied to the packet based on a header of the packet. For example, the header of the packet may indicate that the packet is originated from a HR department device.

In some aspects, a user or a device of the user may be authenticated to access the campus network. For example, the device may transmit an authentication request to a policy enforcement application of the campus network. The authentication request may include user name and password, digital certificates, tokens, and/or other information. The policy enforcement application may forward the authentication request to a remote authentication dial-in user service (RADIUS) server, either within the campus network or remoted located. The RADIUS server may compare the authentication request to data stored in a database. In some aspects, the RADIUS may be located within a remote data center (RDC) that includes a database. In such a case, the database may include authentication information of a plurality of users or devices. For example, the database may include the username and the password of the user. Thus, if the user name and the password included in the authentication request match the user name and the password stored in the database, the RADIUS server may authenticate the user and/or the device. Otherwise, the RADIUS server may deny authentication.

In some aspects, once the user or the device is authenticated, the RADIUS server may transmit a set of network policies to the policy enforcement application. The policy enforcement application may then enforce the set of network policies against packets received from the device. For example, if a packet (or a header of the packet) matches a network policy in the set, the policy enforcement application may apply the network policy to the packet. Specifically, the policy enforcement application may deny or allow the packet based on the network policy. On the other hand, if the packet does not match any network policy, the packet will be dropped based on a zero-trust policy. In some aspects, the set of network policies includes a default policy that matches with any packets. When the packet does not match any other policies in the set, the packet still matches the default policy. In such a case, the policy enforcement application may drop the packet based on the default policy. In other words, the default policy may act as a “match-all” policy that drops packets matching no other network policies.

In some aspects, a network policy may indicate a class of service (CoS). In some aspects, the CoS may include a priority level, one or more resources for transmitting or processing the packet, and so on. Thus, if the header matches the network policy, the policy enforcement application may apply the CoS to the packet based on the network policy.

In some aspects, a user may be remotely located from a campus. For example, the user may be at home or traveling. In such a case, the user device is remote and thus not able to directly access the campus network. However, the user device may still be able to access the private DC or the cloud DC without going through the campus network. In some aspects, the user device may be configured with an agent (or a ZTNA agent). The agent may include a software component that establishes a secured and encrypted connection with an end-point. For example, the end-point can be a service connector at the private DC or the cloud DC. The secured and encrypted connection may be an Internet Protocol Security (IPSEC) tunnel. In some aspects, the secured and encrypted connection may be a Wireguard tunnel. However, the aspects of this disclosure are not limited to this example, and the secured and encrypted connection can include other secured and encrypted protocols. In such a case, the agent may encrypt a packet. The user device may then transmit the encrypted packet to a regional DC, which forwards the encrypted packet to the private DC or the cloud DC. Finally, the service connector may decrypt the packet and retrieve the payload. In some aspects, the service connector may provide services to the user device according to the packet. For example, the packet may include a data query for data stored in the private DC or the cloud DC. The service connector may return the requested data to the user device. In such a case, the user device is able to communicate with the private DC or the cloud DC that would otherwise require access to the campus network.

In some aspects, the user may move from a remote location to the campus. For example, the user may return from the travel or go to the campus for the day. In such a case, the user device may connect to the campus network. However, because the agent has been installed on the user device, packets generated by the user device may still be encrypted by the agent. When the packets arrive at the campus network, the policy enforcement application may not be able to apply network policies to the packet. As discussed above, the packet, such as a user packet, is encrypted by the agent of the user device. Because the policy enforcement application may not be able to decrypt the user packet, the policy enforcement application cannot examine the header of the packet. Consequently, the policy enforcement application cannot match the user packet with any network policies. Thus, the policy enforcement application cannot determine a COS to be applied to the packet.

In some aspects, to solve the above issue, the agent may generate an outer header to be attached to a packet after encryption. For example, the outer header may indicate a CoS corresponding to the packet. In some aspects, the agent may include a policy application that determines the COS based on an application policy that would be applied to the packet. Thus, the agenda can include information of the COS in the outer header, e.g., in a differentiated services code point (DSCP) of the out header. Because the outer header is not encrypted, the policy enforcement application can still apply the CoS based on the outer header without needing to understand the encrypted payload and header. In some aspects, the outer header may include information from the inner header to match a network policy. For example, the outer header may include of either a universal zero trust network access (UZTNA) cloud gateway or a service connector within the campus network. For another example, the outer header may include a medium access control (MAC) address of the agent-based ZTNA user device. In either case, the policy enforcement application may match the outer header with a network policy based on the information. In such a case, the policy enforcement application may apply the CoS that is indicated by the network policy to the packet.

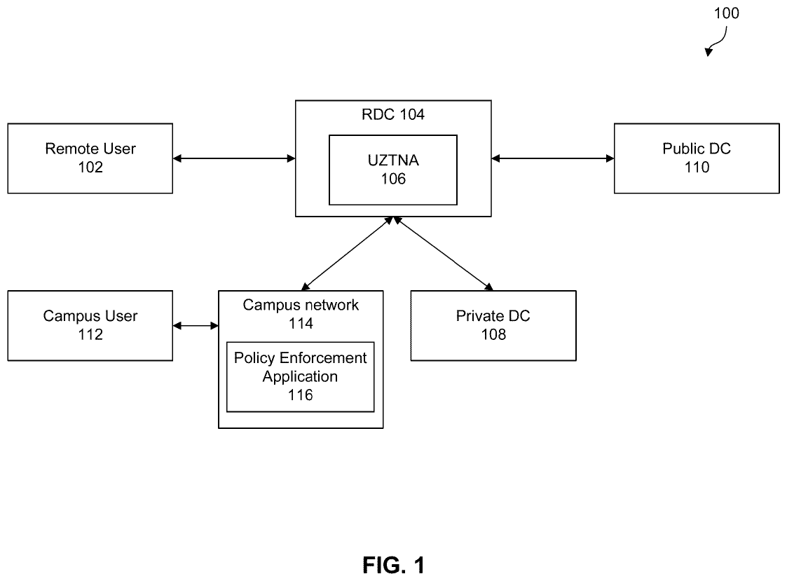

FIG. 1 illustrates an exemplary system 100 that implements an agent-based ZTNA user device access and a campus user device access, according to some aspects. The example system 100 is provided for the purpose of illustration only and does not limit the disclosed aspects. The example system 100 may include, but is not limited to, an agent-based ZTNA user device 102, a RDC 104 that includes a UZTNA 106, a private DC 108, a public DC 110, a campus user device 112, and a campus network 114 that includes a policy enforcement application 116. The policy enforcement application 116 may include a switch and/or an access point (AP) in the campus network 114. In some aspects, the agent-based ZTNA user device 102, the RDC 104, the private DC 108, the public DC 110, the campus user device 112, and the campus network 114 may include, but are not limited to, computer systems, servers, cloud systems, cloud servers, laptops, desktops, personal computers, databases, user equipment, and the like. The public DC 110 can also be a cloud DC. In some aspects, the UZTNA 106 may also be referred to as a universal network access application and the agent-based ZTNA user device 102 and the campus user device 112 may also be referred to as client devices or user equipment (UE).

In some aspects, the campus user device 112 may need to communicate with the private DC 108 and/or the public DC 110. The campus user device 112 may do so by connecting to the campus network 114. For example, the campus user device 112 may connect to the campus network 114 via a wired or wireless connection. Such a connection may require the campus user device 112 to be within a region of the campus network physically. For example, the campus network 114 may be located in a corporate office. In such a case, the campus user device 112 may be required to be physically present in the corporate office. Once within the corporate office, the campus user device 112 may connect to the campus network 114 via a wired connection, such as an Ethernet cable connection, or a wireless connection, such as a WiFi™ connection. In either case, the campus user device 112 may be authenticated via the policy enforcement application 116 of the campus network 114. For example, the policy enforcement application 116 may receive user name and password from the campus user device 112. The policy enforcement application 116 may then transmit them to the UZTNA 106. In some aspects, the UZTNA 106 includes a RADIUS server that verifies the user name and the password to authenticate the campus user device 112. In some aspects, the RADIUS server may transmit a set of network policies to the policy enforcement application 116 once the campus user device 112 is authenticated.

In some aspects, the policy enforcement application 116 stores the set of network policies after receiving it from the RADIUS server. For example, the set of network policies may indicate that packets of the user identity group are allowed to be forwarded to the RDC 104. In some aspects, the UZTNA 106 may include a Network Policy Engine (NPE) that may generate the set of network policies according to an administrator of the campus network 114. For example, the administrator may determine and indicate to the NPE that packets of the user identify group are allowed to be forwarded to the RDC 104. The NPE may then generate network policies accordingly and send them to the policy enforcement application 116. The policy enforcement application 116 may process packets once the set of network policies is received. For example, the campus user device 112 may transmit the packet toward the private DC 108 or the public DC 110. In some aspects, the policy enforcement application 116 of the campus network 114 may examine the packet to determine how to handle the packet. In some aspects, the policy enforcement application 116 may retrieve a header of the packet and determine that the packet is allowed based on the set of network policies. The policy enforcement application 116 may also determine a destination of the packet and forward the packet towards the destination. For example, the policy enforcement application 116 may determine that the destination is the private DC 108 via the RDC 104. In such a case, the policy enforcement application 116 may forward the packet to the RDC 104, which may then forward the packet to the private DC 108. In some aspects, the RDC 104 may further include a relay or a UZTNA cloud gateway that forwards the packet to the private DC 108.

In some aspects, the network policies may also indicate COS. For example, the policy enforcement application 116 may extract the header of the packet and determine that the header matches a network policy. The network policy may indicate a first priority level. In such a case, the policy enforcement application 116 may process the packet based on the first priority level. In some aspects, the policy enforcement application 116 may determine a CoS based on the network policies and the payload of the packet. For example, the policy enforcement application 116 may extract the payload and determine that the payload is a first type payload out of a plurality of payload types. The plurality of payload types may include real-time transmission type, data payload type, and others. The real-time transmission type may correspond to real-time communication, such as streaming, which is sensitive to delays. In some aspects, the first type payload may match a network policy and policy enforcement application 116 may apply the CoS based on the network policy. For example, the policy enforcement application 116 may extract the payload of the packet and determine that the payload is the real-time transmission type. The network policy may indicate resources for the real-time transmission type. Thus, the policy enforcement application 116 may then assign the resources corresponding to the real-time transmission type as indicated by the network policy to the packet, such as resources with a delay smaller than a threshold to the real-time transmission type payload. On the other hand, the data payload type may correspond to large data transmission, such as data backup process, which includes a large amount of data transfer but is insensitive to delays. Similarly, the policy enforcement application 116 may extract the payload and determine that the payload is the data payload type. The network policy may indicate resources for the data payload type. Thus, the policy enforcement application 116 can assign these resources to the packet based on the network policy.

In some aspects, the agent-based ZTNA user device 102 may also need to communicate with the private DC 108 or the public DC 110. However, the agent-based ZTNA user device 102 may be remotely located. For example, the agent-based ZTNA user device 102 may be located at a residence of a remote employee. In such a case, the agent-based ZTNA user device 102 may not be able to directly connect to the campus network 114 and thus the packet may not be protected by the authentication process of the campus network 114. Instead, the agent-based ZTNA user device 102 may transmit packets via a secured tunnel, such as an IPSEC tunnel. In some aspects, the agent-based ZTNA user device 102 may establish the IPSEC tunnel with the private DC 108. For example, the agent-based ZTNA user device 102 may install an agent, such as a ZTNA agent, which can encrypt a packet to be transmitted to the private DC 108. Similarly, the private DC 108 may include a service connector that can decrypt the packet once received. In some aspects, the IPSEC tunnel passes through the RDC 104 to reach the private DC 108. The RDC 104 may include the UZTNA 106 that includes a ZTNA cloud gateway (not shown). The ZTNA cloud gateway may examine the packet and forward the packet to the private DC 108. Thus, the UZTNA 106 is aware of the IPSEC tunnel and end points of the IPSEC tunnel, such as the agent-based ZTNA user device 102 and the private DC 108. In some aspects, the ZTNA cloud gateway can also be referred to as the cloud gateway.

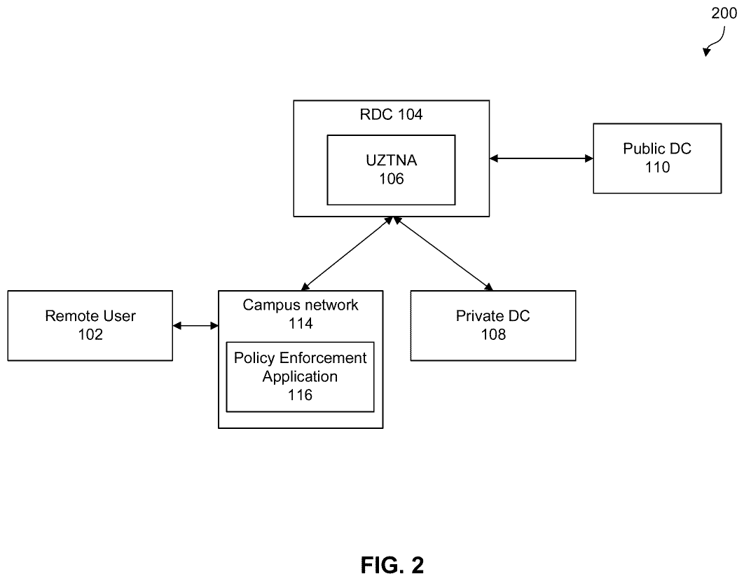

FIG. 2 illustrates an exemplary system 200 that implements an agent-based ZTNA user device access via a campus network, according to some aspects. The example system 200 is provided for the purpose of illustration only and does not limit the disclosed aspects. The example system 200 may include, but is not limited to, an agent-based ZTNA user device 102, a RDC 104 that includes a UZTNA 106, a private DC 108, a public DC 110, and a campus network 114 that includes a policy enforcement application 116. The policy enforcement application 116 may include a switch and/or an access point (AP) in the campus network 114. In some aspects, the agent-based ZTNA user device 102, the RDC 104, the private DC 108, the public DC 110, and the campus network 114 may include, but are not limited to, computer systems, servers, cloud systems, cloud servers, laptops, desktops, personal computers, databases, user equipment, and the like. The public DC 110 can also be a cloud DC. In some aspects, the UZTNA 106 may also be referred to as a universal network access application and the agent-based ZTNA user device 102 and the campus user device 112 may also be referred to as client devices or UEs.

In some aspects, the agent-based ZTNA user device 102 may move to the region of the campus network 114. For example, the user of the agent-based ZTNA user device 102 may go to the corporate office for the day. For another example, the user may have been traveling in the past and now returns from the trip. In either case, the agent-based ZTNA user device 102 may be connected to the campus network 114. The agent-based ZTNA user device 102 may be authenticated similarly as the campus user device 112 as discussed above. However, because the agent has been installed and the IPSEC tunnel has been established, when the agent-based ZTNA user device 102 transmits a packet, the agent may encrypt the packet according to the established IPSEC tunnel. Thus, the policy enforcement application 116 may not be able to analyze the packet because of the encryption. For example, the policy enforcement application 116 may not be able to extract the header or the payload without decrypting the packet. In such a case, the policy enforcement application 116 may not be able to determine COS by applying a network policy to the user packet.

In some aspects, the agent of the agent-based ZTNA user device 102 may generate an outer header and combine the outer header with the encrypted packet. The outer header may indicate a CoS corresponding to the packet. For example, the agent of the agent-based ZTNA user device 102 may determine that the packet is a first type packet corresponding to a first priority level. In such a case, the outer header may indicate the first type packet and/or the first priority level. For another example, the agent of the agent-based ZTNA user device 102 may determine that the payload of the packet is the real-time transmission type corresponding to a first set of resources. In such a case, the outer header may indicate the real-time transmission type or the first set of resources. The agent-based ZTNA user device 102 can then transmit the combined packet to the campus network. In some aspects, the policy enforcement application 116 may extract the outer header from the combined packet. The policy enforcement application 116 may then determine the first priority level and/or the first set of resources to be applied to the packet. In some aspects, the outer header may include information from the inner header to match a network policy. For example, the outer header may include IP addresses and port numbers of the agent-based ZTNA user device and/or the destination, such as a UZTNA cloud gateway. For another example, the outer header may include a medium access control (MAC) address of the agent-based ZTNA user device. In either case, the policy enforcement application 116 may match the outer header with a network policy based on the information. In such a case, the policy enforcement application 116 may apply a CoS that is indicated by the network policy to the packet. For example, the network policy may indicate the first priority level and/or the first set of resources. In such a case, the policy enforcement application 116 applies the first priority level and/or the first set of resources to the packet. In some aspects, the policy enforcement application 116 may remove the outer header and forward the encrypted packet to the RDC 104. In other aspects, the policy enforcement application 116 may forward the combined packet as a whole to the RDC 104. In either case, the policy enforcement application 116 may apply the CoS including the first priority level and/or the first set of resources when forwarding based on the outer header.

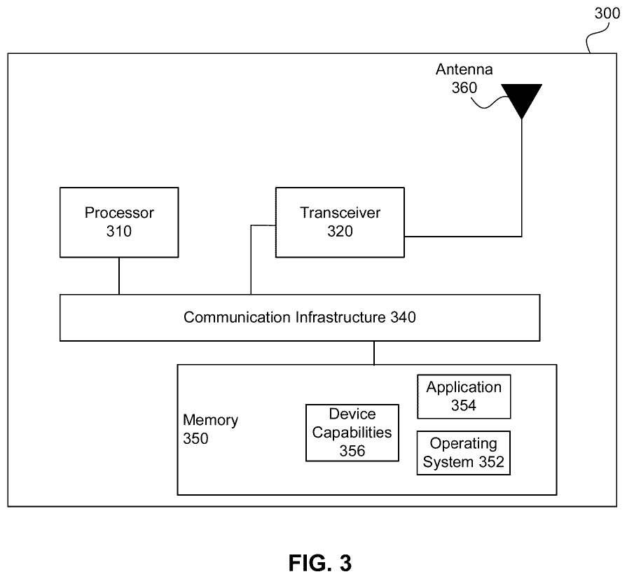

FIG. 3 illustrates a block diagram of apparatuses for application CoS in a ZTNA network, according to some aspects. The electronic device 300 may be any of the electronic devices (e.g., the agent-based ZTNA user device 102, the RDC 104, the private DC 108, the public DC 110, the campus user device 112, and the campus network 114, or a combination thereof of FIGS. 1 and 2) of the systems 100 and 200. The electronic device 300 includes a processor 310, one or more transceivers 320, a communication infrastructure 340, a memory 350, an operating system 352, an application 354, device capabilities 356, and antenna 360. Illustrated systems are provided as exemplary parts of electronic device 300, and electronic device 300 may include other circuit(s) and subsystem(s). Also, although the systems of electronic device 300 are illustrated as separate components, the aspects of this disclosure may include any combination of these, e.g., less, or more components.

The memory 350 may include random access memory (RAM) and/or cache, and may include control logic (e.g., computer software) and/or data. The memory 350 may include other storage devices or memory. According to some examples, the operating system 352 may be stored in the memory 350. The operating system 352 may manage transfer of data from the memory 350 and/or the one or more applications 354 to the processor 310 and/or the one or more transceivers 320. In some examples, the operating system 352 maintains one or more network protocol stacks (e.g., Internet protocol stack, cellular protocol stack, and the like) that may include a number of logical layers. At corresponding layers of the protocol stack, the operating system 352 includes control mechanisms and data structures to perform the functions associated with that layer.

According to some examples, the application 354 may be stored in the memory 350. The application 354 may include applications (e.g., user applications) used by the electronic device 300 and/or a user of the electronic device 300. In some aspects, the device capabilities 356 may be stored in the memory 350.

The electronic device 300 may also include the communication infrastructure 340. The communication infrastructure 340 provides communication between, for example, the processor 310, the one or more transceivers 320, and the memory 350. In some implementations, the communication infrastructure 340 may be a bus.

The processor 310, alone, or together with instructions stored in the memory 350 performs operations enabling electronic device 300 of the system 100 to implement mechanisms for providing packets from an agent-based ZTNA user device CoS in a campus network, as described herein. Alternatively, or additionally, the processor 310 can be “hard coded” to implement mechanisms for providing packets from an agent-based ZTNA user device CoS in a campus network, as described herein.

The one or more transceivers 320 transmit and receive communications signals support mechanisms for providing packets from an agent-based ZTNA user device CoS in a campus network. Additionally, the one or more transceivers 320 transmit and receive communications signals that support mechanisms for measuring communication link(s), generating and transmitting system information and data, and receiving the system information and data. According to some aspects, the one or more transceivers 320 may be coupled to the antenna 360 to wirelessly transmit and receive the communication signals. The antenna 360 may include one or more antennas that may be the same or different types and can form one or more antenna ports. In some aspects, the antenna 360 can be replaced or used in combination with wired communication interferences, such as Ethernet, Universal Serial Bus (USB), serial port, serial advanced technology attachment (SATA), and fiber optic interferences. The one or more transceivers 320 allow electronic device 300 to communicate with other devices that may be wired and/or wireless. In some examples, the one or more transceivers 320 may include processors, controllers, radios, sockets, plugs, buffers, and like circuits/devices used for connecting to and communication on networks. According to some examples, the one or more transceivers 320 include one or more circuits to connect to and communicate on wired and/or wireless networks.

According to some aspects of this disclosure, the one or more transceivers 320 may include a cellular subsystem, a WLAN subsystem, and/or a Bluetooth™ subsystem, each including its own radio transceiver and protocol(s) as will be understood by those skilled in the arts based on the discussion provided herein. In some implementations, the one or more transceivers 320 may include more or fewer systems for communicating with other devices.

In some examples, the one or more the transceivers 320 may include one or more circuits (including a WLAN transceiver) to enable connection(s) and communication over WLAN networks such as, but not limited to, networks based on standards described in IEEE 802.11.

Additionally, or alternatively, the one or more the transceivers 320 may include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, the transceiver 320 may include a Bluetooth™ transceiver. Additionally, the one or more the transceivers 320 may include one or more circuits (including a cellular transceiver) for connecting to and communicating on cellular networks.

As discussed in more detail below with respect to FIGS. 1, 2, and 4-6, processor 310 may implement different mechanisms for providing packets from an agent-based ZTNA user device COS in a campus network as discussed with respect to the system 100 of FIG. 1 and/or the system 200 of FIG. 2.

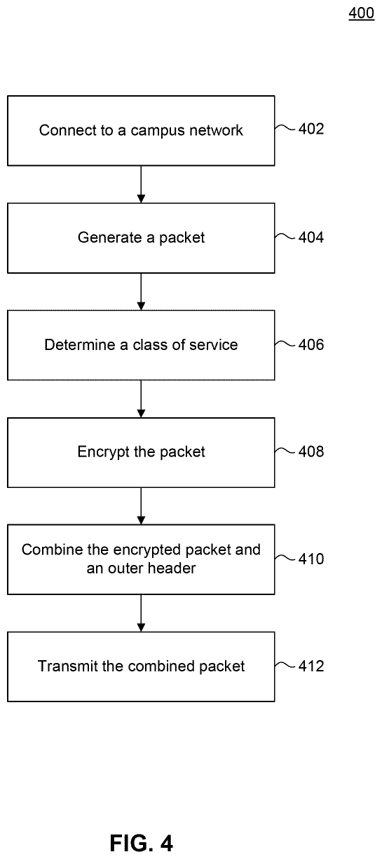

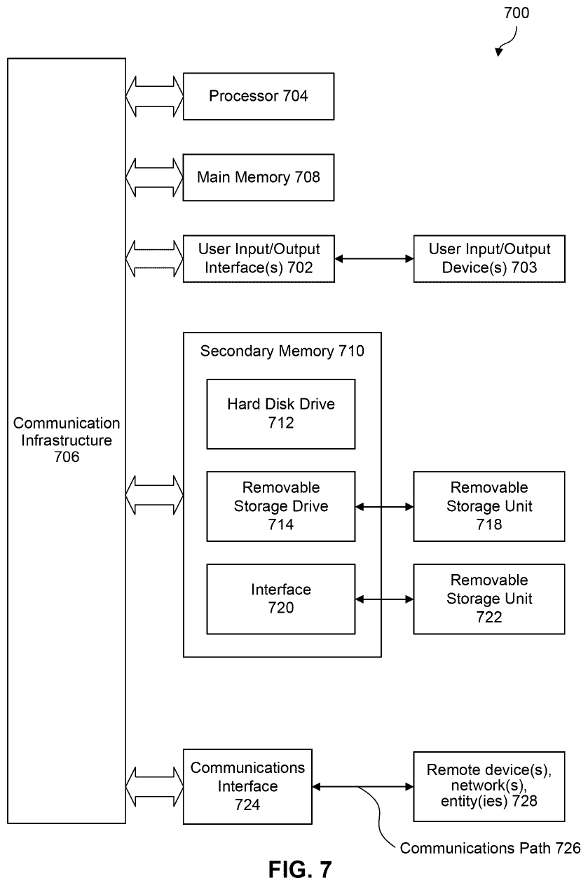

FIG. 4 illustrates an example method 400 of implementing application CoS in the ZTNA network by the agent-based ZTNA user device, according to some aspects. As a convenience and not a limitation, FIG. 4 may be described with regard to elements of FIGS. 1, 2, 3, and 7. The example method 400 may represent the operation of devices (e.g., the agent-based ZTNA user device 102, the RDC 104, the private DC 108, the public DC 110, the campus user device 112, and the campus network 114, or a combination thereof of FIGS. 1 and 2) providing packets from an agent-based ZTNA user device CoS in a campus network. The example method 400 may also be performed by computer system 700 of FIG. 7. But the example method 400 is not limited to the specific aspects depicted in those figures and other systems may be used to perform the method, as will be understood by those skilled in the art. It is to be appreciated that not all operations may be needed, and the operations may not be performed in the same order as shown in FIG. 4.

At 402, a UE, such as the agent-based ZTNA user device 102, may connect to a campus network, such as the campus network 114. In some aspects, the UE may include an agent, such as a ZTNA agent. The campus network can be a ZTNA network. In some aspects, the UE may establish a secured tunnel, such as an Internet protocol security (IPSEC) tunnel, with a service connector in a private DC, such as the private DC 108, or a public DC, such as the public DC 110.

At 404, the UE may generate a packet. In some aspects, the packet may include an inner header and a payload. The inner header may include a transmission control protocol/Internet protocol (TCP/IP) header. In some aspects, the inner header may indicate a first packet type corresponding to a first priority level. Furthermore, the payload may be a real-time transmission type, a data payload type, or other types. In some aspects, the inner header may include information such as IP addresses, port numbers, MAC addresses, and so on as discussed above.

At 406, the UE may determine a CoS based on the packet. In some aspects, the CoS is represented by the information included in the inner header. For example, the information can be an IP address and a port number of a destination of the packet, such as a UZTNA cloud gateway or the service connector of the private DC. For another example, the information can be the MAC address of the UE. In other aspects, the UE can extract the inner header and determine that the CoS includes the first priority level because the inner header indicates the first packet type. In addition, the UE can extract the payload and determine that the payload is a real-time transmission type. In such a case, the CoS may include a first set of resources corresponding to the real-time transmission type.

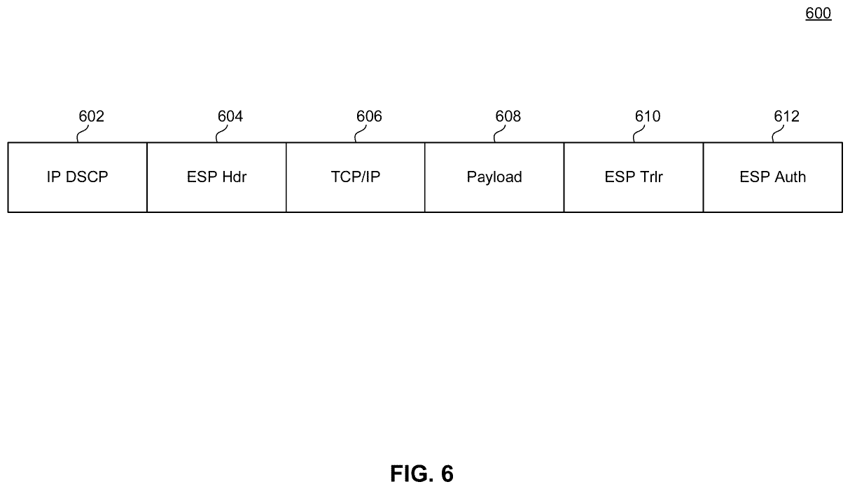

At 408, the UE may encrypt the packet including the inner header and the payload. In some aspects, the UE may also add an encryption header, an encryption trailer, and/or an encryption authentication to the encrypted packet, as shown in more detail below in FIG. 6.

At 410, the UE may combine the encrypted packet and an outer header. In some aspects, the UE may generate the outer header based on the CoS determined in 406. For example, the outer header may include the information, such as the IP address and the port number of the destination of the packet and/or the MAC address of the UE. For another example, the outer header may indicate the first packet type and/or the first priority level corresponding to the packet. In addition, the outer header may also indicate the real-time transmission type and/or the first set of resources. In some aspects, the UE may generate a combined packet by combining the encrypted packet and the outer header.

In some aspects, the outer header may include an Internet protocol differentiated services code point (IP DSCP) header. In addition, the UE may generate the combined packet in response to connecting to the campus network in 402. For example, when the UE, such as the agent-based ZTNA user device 102, connects to the private DC 108 or the public DC 110 via the RDC 104 and the campus network 114, as discussed in FIG. 2 above, the UE may generate the combined packet. On the other hand, when the UE, such as the agent-based ZTNA user device 102, connects to the private DC 108 or the public DC 110 via the RDC 104 without connecting to the campus network 114, as discussed in FIG. 1 above, the UE may refrain from generating the combined packet. Thus, the step 410 may be skipped. Similarly, the step 406 may also be skipped if the UE does not connect to the campus network.

At 412, the UE may transmit the combined packet to the campus network. In some aspects, if the UE does not connect to the campus network, the UE may refrain from generating the combined packet as discussed above. In such a case, the UE may transmit the encrypted packet to an RDC, such as the RDC 104, as discussed in FIG. 1 above. On the other hand, if the UE connects to the campus network, the UE may transmit the combined packet to the campus network.

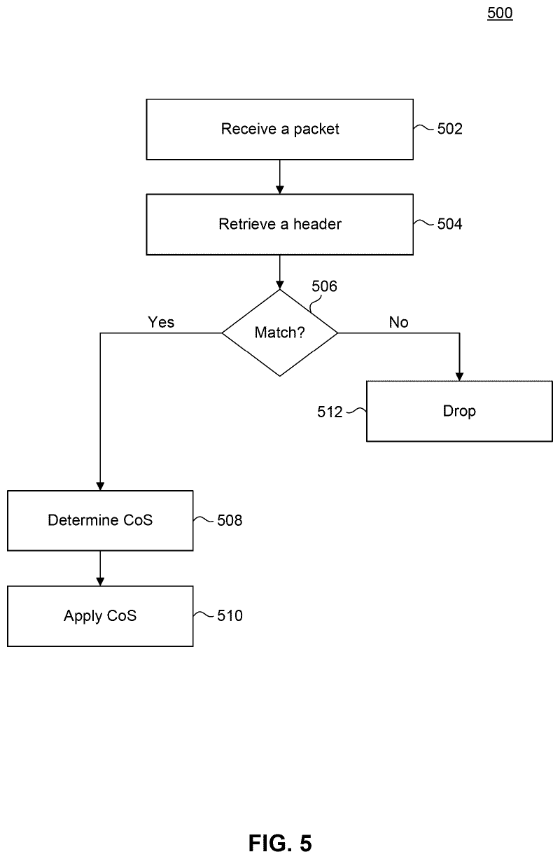

FIG. 5 illustrates an example method 500 of implementing application CoS in the ZTNA network by a policy enforcement application, according to some aspects of the disclosure. As a convenience and not a limitation, FIG. 5 may be described with regard to elements of FIGS. 1, 2, 3, and 7. The example 500 may represent the operation of devices (e.g., the campus network 114 and the policy enforcement application 116 of FIGS. 1 and 2) providing packets from an agent-based ZTNA user device CoS in a campus network. The example method 500 may also be performed by computer system 700 of FIG. 7. But the example method 500 is not limited to the specific aspects depicted in those figures and other systems may be used to perform the method, as will be understood by those skilled in the art. It is to be appreciated that not all operations may be needed, and the operations may not be performed in the same order as shown in FIG. 5.

At 502, a policy enforcement application, such as the policy enforcement application 116, receives a packet from a UE, such as the agent-based ZTNA user device 102. In some aspects, the packet is a combined packet as discussed in 410 and 412.

At 504, the policy enforcement application may retrieve a header from the packet. In some aspects, the header is an outer header and the packet includes the outer header and an encrypted packet as discussed in 410. In other aspects, the header is an inner header and the packet is not encrypted as discussed above.

At 506, the policy enforcement application may determine whether the header matches a network policy. In some aspects, the policy enforcement application may receive a set of network policies from a UZTNA, such as the UZTNA 106, and try to match the header with a network policy in the set. For example, the header may indicate an IP address and a port number. The policy enforcement application may determine that a network policy in the set also indicates the IP address. For another example, the header may indicate a MAC address and the network policy may also indicate the MAC address. In either case, the policy enforcement application may determine that the header matches a network policy and the control moves to 508. In some aspects, the set of network polices may include a default policy. As discussed above, if the header does not match any other network policies in the set, the packet can still match the default policy. However, the default policy may indicate dropping any matching packets. Thus, if the packet matches a network policy in the set that is not the default policy, the control moves to 508.

At 508, the policy enforcement application may determine a CoS based on the matching network policy. For example, the network policy may indicate a level of priority and/or a set of resources.

At 510, the policy enforcement application may apply the CoS to the packet. For example, the policy enforcement application may apply the level of priority to the packet and/or use the set of resources to transmit the packet.

Referring back to 506, if the policy enforcement application determines that no network policy other than the default policy matches the header, the control moves to 512. At 512, the policy enforcement application may drop the packet because of the zero-trust policy or the default policy. Since the packet is dropped, no CoS is applied to the packet.

FIG. 6 illustrates an example combined packet 600 for implementing application CoS in the ZTNA network, according to some aspects of the disclosure. As a convenience and not a limitation, FIG. 6 may be described with regard to elements of FIGS. 1, 2, 3, and 7. The example 600 may represent a combined packet used during the operation of devices (e.g., the agent-based ZTNA user device 102, the RDC 104, the private DC 108, the public DC 110, the campus user device 112, and the campus network 114, or a combination thereof of FIGS. 1 and 2) providing packets from an agent-based ZTNA user device CoS in a campus network.

In some aspects, the combined packet 600 may be the combined packet discussed in 410 and/or the packet received in 502. The combined packet 600 may include an IP DSCP 602, an encapsulating security payload (ESP) header 604, a TCP/IP header 606, a payload 608, an ESP trailer 610, and an ESP authentication 612. In some aspects, the TCP/IP header 606 and the payload 608 may form the packet generated by the UE in 404. When the UE encrypts the packet in 408, the UE may first encrypt the TCP/IP header 606 and the payload 608. The UE may then add the ESP header 604, the ESP trailer 610, and an ESP authentication 612 to the encrypted packet.

In some aspects, the ESP header 604 may include information needed for processing the packet, such as the Security Parameters Index (SPI) and the sequence number. The ESP header 604 may also indicate IP addresses and port numbers of a source and a destination. For example, the ESP header 604 may indicate an IP address and a port number of the UZTNA cloud gateway in FIG. 2, which is a destination of the packet. The ESP header 604 may alternatively or additionally indicate an MAC address of the UE. The ESP trailer 610 may include padding, the next header field, and ensures the payload is properly aligned for encryption algorithms that require data to be in specific block sizes. Finally, the ESP authentication 612 may provide data integrity and authenticity for the ESP header 604, the encrypted packet, and the ESP Trailer 610.

In some aspects, the IP DSCP 602 may be the outer header discussed in 410, 504, and 506. The IP DSCP 602 may include a predetermined number of bits, such as 6 bits, and be placed at the beginning of the combined packet. Thus, the policy enforcement application may retrieve the IP DSCP 602 by extracting the predetermined number of bits at the beginning of the combined packet.

Various aspects may be implemented, for example, using one or more computer systems, such as computer system 700 shown in FIG. 7. One or more computer systems 700 may be used, for example, to implement any of the aspects discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture including a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 7. In particular, aspects can operate with software, hardware, and/or operating system implementations other than those described herein.

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described can include a particular feature, structure, or characteristic, but every aspect can not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

What is claimed is:

1. A user equipment (UE), comprising:
a memory;
at least one processor coupled to the memory and configured to:
generate a packet that includes a payload and an inner header;
generate an encrypted packet by encrypting the packet;
generate a combined packet based on the encrypted packet and an outer header, wherein the outer header indicates a class of service corresponding to the packet; and
transmit the combined packet to a campus network via a secured tunnel.

2. The UE of claim 1, wherein the outer header further indicates a permission to access the campus network.

3. The UE of claim 1, wherein the campus network is a zero trust network access (ZTNA) network.

4. The UE of claim 1, wherein to generate the combined packet, the at least one processor is further configured to:
determine the class of service based on the packet; and
generate the outer header based on the class of service.

5. The UE of claim 1, wherein the secured tunnel is an Internet protocol security (IPSEC) tunnel or a wireguard tunnel.

6. The UE of claim 1, wherein the outer header is an Internet protocol differentiated services code point (IP DSCP) header.

7. The UE of claim 1, wherein the inner header is a transmission control protocol/Internet protocol (TCP/IP) header.

8. The UE of claim 1, wherein the at least one processor is further configured to:
connect to the campus network; and
in response to connecting to the campus network, generate the combined packet.

9. A method of a user equipment (UE), comprising:
generating a packet that includes a payload and an inner header;
generating an encrypted packet by encrypting the packet;
generating a combined packet based on the encrypted packet and an outer header, wherein the outer header indicates a class of service corresponding to the packet; and
transmitting the combined packet to a campus network via a secured tunnel.

10. The method of claim 9, wherein the outer header further indicates a permission to access the campus network.

11. The method of claim 9, wherein the campus network is a zero trust network access (ZTNA) network.

12. The method of claim 9, wherein the generating the combined packet further comprises:
determining the class of service based on the packet; and
generating the outer header based on the class of service.

13. The method of claim 9, wherein the secured tunnel is an Internet protocol security (IPSEC) tunnel or a wireguard tunnel.

14. The method of claim 9, wherein the outer header is an Internet protocol differentiated services code point (IP DSCP) header.

15. The method of claim 9, wherein the inner header is a transmission control protocol/Internet protocol (TCP/IP) header.

16. The method of claim 9, further comprising:
connecting to the campus network; and
in response to connecting to the campus network, generating the combined packet.

17. A non-transitory computer-readable medium (CRM) comprising instructions to, upon execution of the instructions by one or more processors of a user equipment (UE), cause the UE to perform operations, the operations comprising:
generating a packet that includes a payload and an inner header;
generating an encrypted packet by encrypting the packet;
generating a combined packet based on the encrypted packet and an outer header, wherein the outer header indicates a class of service corresponding to the packet; and
transmitting the combined packet to a campus network via a secured tunnel.

18. The non-transitory CRM of claim 17, wherein the outer header further indicates a permission to access the campus network.

19. The non-transitory CRM of claim 17, wherein the generating the combined packet further comprises:
determining the class of service based on the packet; and
generating the outer header based on the class of service.

20. The non-transitory CRM of claim 17, wherein the operations further comprise:
connecting to the campus network; and
in response to connecting to the campus network, generating the combined packet.
